(19) United States
(12) Patent Application Publication
(10) Pub. No.: US 2015/0170141 A1
(43) Pub. Date: Jun. 18, 2015

(54) SYSTEM AND METHOD FOR SUPPORTING ANALYTICS AND VISUALIZATION BASED ON TRANSACTION AND WALLET DATA

(71) Applicant: Apriva, LLC, Scottsdale, AZ (US)

(72) Inventor: Michael S. Klingen, Paradise Valley, AZ (US)

(21) Appl. No.: 14/318,023

(22) Filed: Jun. 27, 2014

Related U.S. Application Data
(63) Continuation of application No. 14/132,820, filed on Dec. 18, 2013.
Application No. 14/132,820 is a continuation of application No. 14/132,836, filed on Dec. 18, 2013.

(51) Int. Cl. G06Q 20/40; G06Q 20/02; G06Q 20/36

(52) U.S. Cl. CPC G06Q 20/40; G06Q 20/36; G06Q 20/027

(57) ABSTRACT

The present invention relates generally to a system and device for compartmentalizing data acquisition functions within various hardware and software components and web services. More specifically, the system comprises a number of data providers including web services configured to receive transaction parameters from a payment network gateway system. The gateway system routes payment requests to appropriate payment processors and further parses the payment request for parameters. An information request including the parameters is sent to a cataloging service, which selects one or more web services based on the information request and parameters. The cataloging service sends the parameters to the one or more web services, which retrieves information based on a parameter and returns the information to the gateway server. The gateway server processes the information with the original transaction data and stores the combined information in a database.

### CROSS-REFERENCE TO RELATED APPLICATIONS

This application is a continuation of, and claims priority to U.S. patent application Ser. No. 14/132,820, filed Dec. 18, 2013 and also claims priority to U.S. patent application Ser. No. 14/132,836 filed on Dec. 18, 2013.

### FIELD OF INVENTION

The disclosed system and method facilitates accumulation, processing, and management of meaningful transactional data by combining merchant information with third-party information sources. Information from a plurality of sources is obtained by hardware/software components and web services that are configured to locate and retrieve information that directly or indirectly relates to any subset of collected transactional data.

### BACKGROUND

The computer and electronics industry has greatly increased in ability to engineer and construct computing devices having very small footprints with capabilities that dwarf their older and larger counterparts. These technologies are frequently far less expensive that preceding solutions, making it possible to collect and store once unimaginable amounts of data. The broad possibilities of new technologies have raised concerns among some privacy groups and have also stirred anxieties among those who are concerned about handing over more power to already powerful corporate and/or governmental entities. As such, various laws and standards have been implemented to help ensure that consistent policies are universally implemented to protect information that is considered private or sensitive. Still, some remain skeptical and continue to believe that too much information is collected and maintained and worry about the implications this might have to their personal privacy.

Developers continue to pursue methods for maintaining the delicate balance between providing for the collection of useful demographic information while reassuring consumers that their personal and private information will not be compromised. This has been especially challenging because in order to achieve the objectives of highly targeted marketing and even consumer specific promotions, some level of personal information must be known. However, as companies, organizations, and governmental entities have cooperated to develop privacy laws and standards regarding the appropriate use of personal data, consumers have become increasingly trusting of certain organizations that accumulate and use personal static and transactional data to deliver offers and promotions that are particularly relevant to the consumer. This highly targeted marketing serves to save the marketer significant expense in developing across the board campaigns that may only be of interest or even relevant to small subset of a market.

As such, there is a need for a method of obtaining data that is useful to marketing efforts while ensuring the privacy of individuals that the data represents. While methods for receiving demographic data have existed for many years, this information generally categorizes consumers into only several groups having similarities in income, family size, education level, profession, etc. However, it has become apparent that consumers are not so easily grouped or categorized. A system is needed for allowing much smaller groups of consumers to be linked in accordance with any number of highly specific variables and in consideration of subtle differentiators, such that marketing efforts can be semi-customized while maintaining complete anonymity for targeted consumers.

More specifically, a system is needed that is configured to retrieve data from disparate sources in order to construct a more detailed view of a consumer or transaction. The system should be configured such that data can be retrieved through an iterative process, wherein data retrieved from a first source may be used as a parameter to locate related data from a second source. Through such an iterative process, retrieved data may itself be used to locate and capture even more data, such that the amount of data that can be retrieved is limited only by the number of participating data sources.

### SUMMARY OF THE INVENTION

In general, the invention overcomes the limitations and problems of prior art systems by providing a system and device that is configured to retrieve a payment authorization request from a point of sale (POS) device, retrieve information corresponding to the request by a wallet gateway, send request parameters to an appropriate payment processor, and send request message information to a cataloging service, which invokes identified web services to retrieve transaction related information.

In one embodiment, information is acquired from various sources during a purchase transaction, wherein the information is collected from among the components having tasks pertinent to the facilitation of a transaction, specifically in a mobile environment. The primary components may include, for example, a mobile communications device (e.g., smartphone), a POS device or system for compiling industry standard ISO 8583 messages, a wallet system, including a wallet gateway; and a number of web services.

In one embodiment, the system (i.e., “acquisition system”) includes additional components, wherein the components may be classified as sub-components of the primary acquisition system components. For example, web services may include a directory service or cataloging service, which resides at a server and maintains information pertaining to a number of available web services, the features provided by each service, and the type and format of required parameters for each specific web service. In one embodiment, a cataloging service or directory service may include logic for identifying one or more web services to perform a task based on an assessment of a web service consumer's needs.

In one embodiment, a cataloging service maintains a directory of available web series. The cataloging service is able to dispatch calls to a number of web services, which are each configured to parse information from the request parameters to query internal and/or external data sources for information relating to the parameters. For example, one of the parameters may include the merchant's postal code. The postal code is sent to a web service that is configured to retrieve weather related information. The web service uses the postal code to query a weather database to determine the weather conditions at the merchant's location at the time of the sales transaction. This information may then be stored with the parameter data along with any other information obtained by additional web services.

In one embodiment, the acquisition system collects, processes, and maintains information relating to a number of consumers. Information is maintained in an anonymous manner, such that any information provided to data consumers directly or indirectly relates to a group of unidentified consumers. For example, a data consumer may request a profile representing the typical product customer that accounts for 80% of a sporting goods store. The profile might include information such as gender, age, income, residence type, residence location, marital status, number of children, vehicle ownerships, etc. Therefore, the profile is a representation of the typical customer of the store. However, the profile does not include any information that identifies a particular consumer that is a part of the profile. In this manner, data representing a typical consumer may be released to an acquisition system subscriber without receiving explicit authorization.

In one embodiment, information is made available to subscribers, which may be specific to an identified user or a group of users. To adhere to privacy laws, a consumer may be required to opt-in to allow his or her personal information to be shared. Moreover, a consumer may select what type of information that the consumer is willing to share. For example, the consumer may allow information identifying the merchants that the consumer purchased from over a period of time. However, the consumer may not wish to expose the products that were purchased from the merchants. In other words, the consumer should be able to determine how much data to expose when their personal identity is exposed to subscribers.

In one embodiment, the acquisition system provides real-time customer demographic information to a merchant at the time of sale. The acquisition system may select offers or discounts for the merchant to offer to a consumer at the time of a sales transaction. For example, the wallet gateway receives a payment request from a merchant and parses the request to obtain parameters that are to be passed to selected web services. The web services collect information in accordance with the parameters and the wallet gateway selects an offer or promotion that correlates with information retrieved by the web service. The promotion or offer data is returned to the POS along with an authorization message, where it may be presented to the consumer by the merchant or the merchant POS device.

More specifically, the wallet gateway receives transaction authorization requests from a POS device or remote device and determines the appropriate payment processor to authorize the transaction. The wallet gateway is further configured to parse the transaction request to extract parameters that may be used to obtain additional information relating to the transaction (e.g., consumer identifier, merchant, identifier, transaction type, item identifier, purchase location, etc.). The wallet gateway sends one or more parameters to a selected one or more web services, which uses the parameter(s) to retrieve additional information from disparate data sources. The additional information is sent from the web service(s) to the wallet gateway, which selects promotion and/or offer data based on the web service information and sends the data to the POS device or remote device along with the authorization request received from a payment processor. The offers and/or promotions may be selected from a set of offers and promotions defined by the merchant. For example, the merchant may define an offer that states that a customer is to receive 10% off of the purchase price at the time of sale when the customer has previously shopped at a competing merchant.

In one embodiment, a gateway server receives a payment authorization request from a merchant POS device and parses the payment authorization request to obtain transaction data. The gateway server directly or indirectly sends a subset of the transaction information to a web service, wherein the web service retrieves supporting data from a computing system, the supporting data being retrieved based on its relation to a parameter selected from the subset and, wherein the supporting data is sent to the gateway server. The gateway server processes the supporting data to combine the transaction data with the supporting data and stores the combined data in a database system.

### BRIEF DESCRIPTION OF EXEMPLARY DRAWINGS

A more complete understanding of the present invention may be derived by referring to the detailed description and claims when considered in connection with the Figures, wherein like reference numbers refer to similar elements throughout the Figures, and:

FIG. 1 is a table listing categorized examples of information sources including hardware systems, software, and web services in accordance with an exemplary embodiment of the present invention;

FIG. 2 is a flow diagram illustrating a process steps for processing transaction data and executing a number of web services to create a holistic view of the transaction in accordance with an exemplary embodiment of the present invention;

FIG. 3 is a combination system diagram and flow diagram illustrating acquisition system components and their interactions for batch augmentation of historic transactional data with relevant historical data in accordance with an exemplary embodiment of the present invention; and

FIG. 4 is a combination system diagram and flow diagram illustrating acquisition system components and their interactions for real-time augmentation transactional data with relevant historical data in accordance with an exemplary embodiment of the present invention.

### DETAILED DESCRIPTION OF EXEMPLARY EMBODIMENTS

In general, the present system uniquely contributes to and provides information from a computerized data provisioning service. The provisioning service (i.e., “wallet gateway”) may comprise any number of web services, applets, functions, and the like, each configured to provide one or more service relating to locating a data source, establishing a connection with the data source, collecting specific information from the data source, formatting the data in accordance with a requesting entity, and returning the formatted request to the requesting entity.

As used herein, a web service is a program that is configured to perform one or more specialized functions. More specifically, a web service as referred to herein stores or collects information among one or more disparate servers that are connected to the Internet or an Intranet. Web services are typically owned and maintained by a third-party entity, such that many competing services may be made available to application developers for use in their applications and systems. Web service owners may host their services on proprietary servers or host them on commercial Internet servers. Access to services may be open, meaning credentials are not needed to utilize the services. Web services may be provided to paying subscribers and the fee structure may be implemented based on usage, a period of time, and the like.

In one embodiment, web services may be owned and maintained by the entity owning and maintaining the disclosed acquisition system. In accordance with this embodiment, the features provided by the “web services” may instead be encapsulated within code modules including, for example, objects, functions, methods, and procedures. For consistency, the features provided by such specialized modules; whether they comprise internal code modules or external web services, will herein be referred to as web services.

A web service may comprise a software method provided at a network address over the web or cloud server; it is a service that is “always on” as in the concept of utility computing. A web service may have access to secure systems that are not normally accessible by other than authorized users. The web service, itself an “authorized user” is allowed to access data on the secure system in accordance with permissions granted to the web service. In turn, the web service may further limit the data that it makes available to users of the web service. In this way, valuable data may be provided to users that would not otherwise have access to the secure system, while also ensuring that the integrity of the secure system is maintained and insulated. The web service ensures that only designated data is exposed to users of the web service

In an embodiment, a web service receives information from a wallet gateway that facilitates electronic wallet applications such as could be provided on a mobile device for effectuating payment transactions, managing transaction instruments and information, merchant and user information, and so forth. Typically, the wallet gateway receives a payment authorization request from a merchant POS device, determines the appropriate payment processor to receive the request, formats the request in accordance with the processor's specific requirements, and sends the formatted request to the processor. Further to processing the authorization request, the wallet gateway receives the request, parses data from the request that can be used to obtain additional information relating to the consumer, and sends the parsed data as parameters to one or more web services.

In one embodiment, a payment network, including the wallet gateway, further includes a payment gateway. The payment gateway communicates directly with the wallet gateway in order to receive the authorization request, identify the proper payment processor based on information in the request, and route the request to the identified payment processor. Those of ordinary skill in the art will appreciate the full scope and features provided by a payment gateway within a typical payment network. However, it should be appreciated that the wallet gateway may interact with the payment gateway to simply pass on the authorization request that is received from the merchant POS device. However, interaction between the wallet gateway and the payment gateway may be unique in accordance with the disclosed acquisition system. For example, the wallet gateway may add information to the standard authorization request prior to sending it to the payment gateway, such that the payment gateway is aware that a received response message needs to be routed back through the wallet gateway. In another embodiment, the authorization response may be sent to directly to the POS device in the conventional manner. Arrangement of the processing tasks between the wallet gateway and the payment gateway is a design choice only, and does not modify or otherwise impact the scope of the invention in any way.

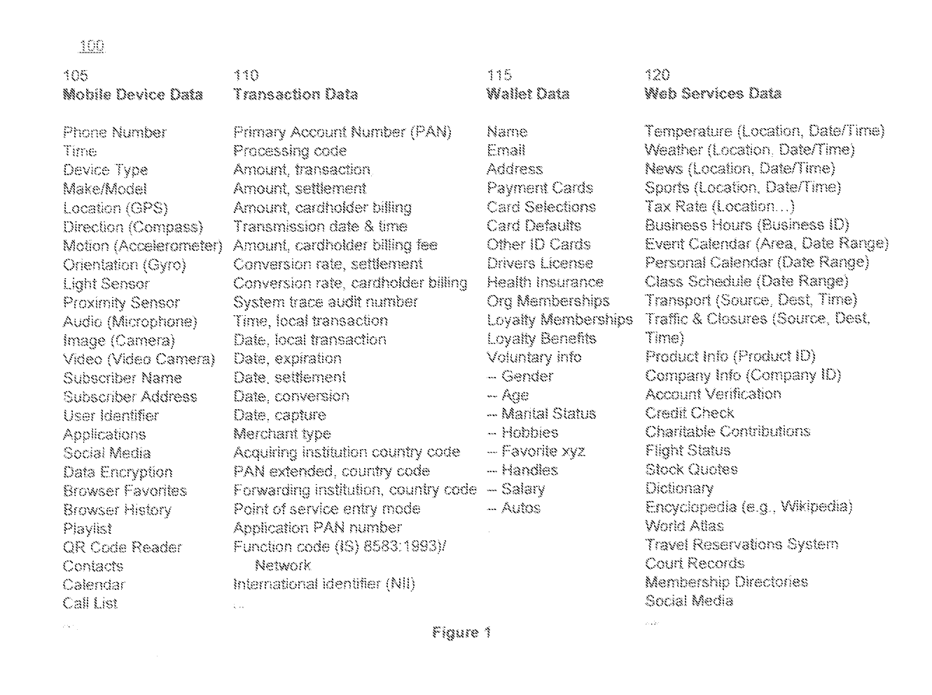

In one embodiment, the web services comprise functions that receive parameters from a from the wallet gateway. Web service parameters may include location data, payment instrument information, financial transaction data, POS transaction data, consumer identifier, merchant identifier, device identifier, etc. Parameters are dynamic values that can be processed along with other dynamic values and/or static data to return useful information to any of the entities disclosed herein. Web service parameters may be obtained from data derived from a variety of available data sources. FIG. 1 is a table listing examples of such data categorized into four types: mobile device data 105, transaction data 110, wallet data 115 and web service data 120. It should be understood that such information could be categorized in other ways and/or more categories may exist. Furthermore, FIG. 1 is presented for explanation only and should not be understood to be limiting in nature. The disclosed acquisition system may utilize any source of information that is accessible and relevant to the purposes at hand.

As examples of mobile device data 105, purchase transactions and other potentially relevant activities that are facilitated by a mobile device (such as a Smartphone enabled for internet access) can provide valuable data relating to the precise location of the customer at the time of a purchase transaction, the general environmental factors at transaction time, customer preferences as indicated by web browser favorites, web browsing history, installed applications, etc. Such data is obtainable via the operating system and hardware components of the mobile device. While the unique features of the acquisition system presented herein apply primarily to a wireless environment including a mobile device, it should be appreciated the aspects of the disclosed acquisition system may be applicable within additional hardware, software, and networking configurations as well (e.g., non-mobile devices, such as conventional laptop and desktop computers).

As examples of transaction data 110, an ISO 8583 message can provide valuable information pertaining to details of the transaction including the merchant, the payment processor, and taxing authorities. As used herein, ISO 8583 is an industry standard that defines a message format and a communication flow so that different systems can exchange transaction authorizations requests and responses. While the authorization request and response messages are described in the context of ISO 8583, those of ordinary skill in the art will appreciate that any present or future industry standard or proprietary messaging structure may be implemented within the framework of the described acquisition system without departing from the scope of the invention.

Transaction data 110 is an example of the types of data that are transported over a payment network within an ISO 8583 message. The data fields shown in chart 100 represent only a portion of the fields available in such a message. Conventionally, the data fields in the ISO 8583 are used by the various systems within a payment network to route, process, and record transactions in sufficient detail to enable the electronic transfer of funds from a payer to a merchant, for example. This data is conventionally used for additional purposes that are outside of the scope of the described acquisition system, therefore they will not be discussed herein. Those of ordinary skill in the art will recognize that having access to such data contained in multiple ISO 8583 messages may be useful for analytics and planning tasks. However, distribution and use of such data is uncommon due to privacy concerns. As such, the disclosed acquisition system seeks to utilize various elements of an ISO 8583 in a manner that ensures the privacy of the originating consumers and merchants.

As described herein, data elements within an ISO 8583 message may be used as parameters for locating and retrieving non-private data from any number of disparate database systems for the purpose of constructing an accurate persona of a consumer or group of consumers. As such, private data remains private while facilitating collection of public data that directly or indirectly relates to the consumer, the merchant, and a number of transaction specific information types. However, it should be understood that the disclosed acquisition system does not disclaim the direct use of private data in compliance with relevant laws and regulations.

As an example of using private data to obtain public data is the use of a cardholder identifier to be used as a search parameter by a web service that is configured to query one or more social networks to locate information relating directly to the consumer. Such information may include, for example, family size, likes, interests, occupation, school, education level, and the like. While this example may or may not be considered improper use of private data, it serves to illustrate how private information may facilitate locating related public information relating to a consumer or group of consumers for the purpose of providing meaningful information for data analytics and planning.

As examples of wallet data 115, an electronic wallet application may maintain a large amount of personal information relating to the customer. Access to a customer's wallet can be provided through the disclosed wallet gateway or by any means known in the art. For example, a third-party hosted wallet may be shared in accordance with the owner's preferences. The disclosed acquisition system may allow the customer to provide their user ID and password to grant the acquisition system access to their wallet for future transactions. Those of ordinary skill in the art will appreciate that there are a number of schemes used to incent customers into sharing his or her wallet information including, for example, offering a discount on an item, issuing a number of loyalty points, provide a free item, providing coupons, entering the customer into a drawing for prizes, and the like.

As examples of web service data 120, information may be obtained from web services relating to weather conditions including temperatures and precipitation; local and world news; sports news; traffic conditions including road closures and accidents; mass transit; travel services; calendars including community, group, company, and personal calendars; event schedules; company directories; company information and news; product information; financial information including investments, bank accounts, stock quotes; verifications including verifications for accounts, identities, credit, memberships, credentials, awards, and reputation; loyalty memberships; medical information; environmental conditions; residential addresses and contact information (white pages), and the like. Such web services that may be implemented by the disclosed acquisition system may reside on a single server at a single location and owned by a single entity. However, as is commonly the case, the web services may reside on many different servers that are disparately located and owned by unrelated entities.

In one embodiment, a cataloging service sits between the wallet gateway and a plurality of web services. Those or ordinary skill in the art will appreciate that details (e.g., web service description, required parameters, returned data format, etc.) corresponding to web services are typically cataloged within a web service directory. As used herein, the web service directory is managed by a cataloging service, which may be a proprietary service that is exclusive to the wallet gateway or a standalone service accessible to the general public and/or subscribers. Likewise, the cataloging service may exist as an application residing on the same server that hosts the wallet gateway, a dedicated server within a payment network, or a public or private server residing outside of a payment network. The physical location of the cataloging service does not affect the scope of the invention.

The cataloging service maintains an updated list of available web services and data definitions. Data definitions allow the cataloging service to categorize the parameters into data types in order to identify and send the parameters to the identified web services. For example, the cataloging service may receive an identifier for the consumer. A web service having access to private data may receive the consumer identifier from the cataloging service as a parameter. Using the parameter, the web service queries a consumer database, locates a matching consumer identifier, and retrieves information further defining the consumer. For example, the consumer database indicates that the person corresponding to the consumer identifier is 43 years old, is married, has two children, and earns an annual salary of between 75K and 85K. This information is returned to the cataloging service which then sends the product identifier and merchant identifier along with the consumer information to a second web service. The second web service may obtain more information relating to the product identifier or the merchant identifier. Finally, a web service records all of the information known about the purchase to an appropriate one or more demographic database.

When the above process is repeated over a period of time and a number of transactions, the cataloging service is increasingly able to provide valuable demographic data to subscribers in relation to real-world data. For example, the acquisition system subscriber may want to know all about the typical purchaser of Mac Cosmetics. From the data collected by the cataloging service, the acquisition system subscriber is provided a very detailed image of the consumer, without necessarily exposing consumer's identity. This significantly enhances the acquisition system subscriber's marketing efforts through directing offers and promotions to consumers with a precision that is just short of having the identity of the consumer directly.

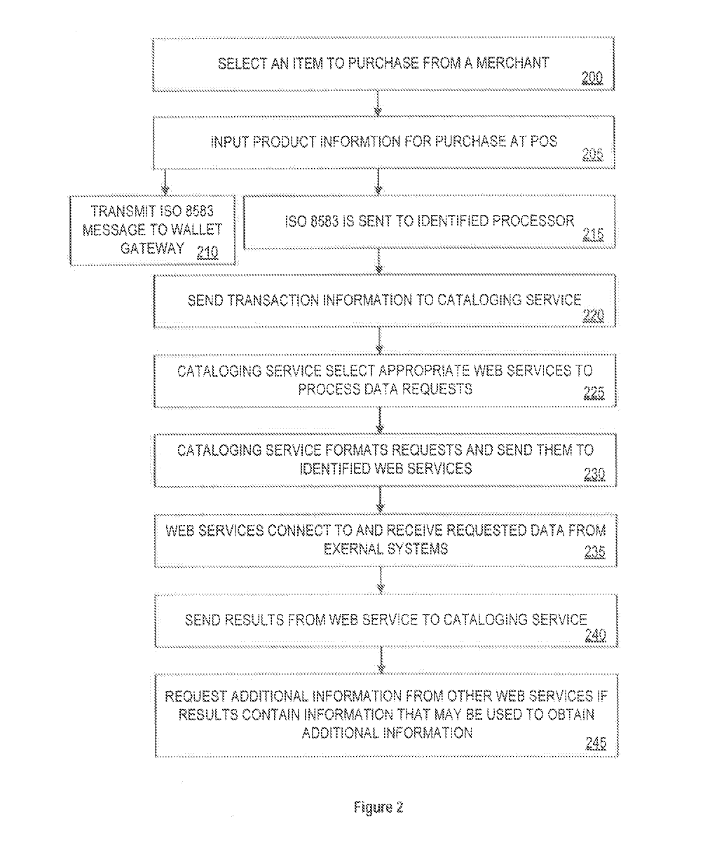

FIG. 2 is a flow diagram illustrating process steps for processing transaction data and executing a number of web services to create a holistic view of the transaction in accordance with an exemplary embodiment of the present invention. As used herein, demographic data comprises information beyond what is known about a consumer at the time of a sales transaction or any other type of interaction with the consumer. The disclosed acquisition system seeks to expand demographic data to include information beyond what is supplied by the consumer or merchant, for example. The acquisition system incorporates a cascading model, wherein a plurality of databases and computing systems are queried based on minimal information obtained from a consumer or merchant. In turn, information that is returned based on such queries may further be used to query additional computing systems and databases for even more information. This process can be repeated through several layers and iterations until the amount of information relating to a particular consumer is extensive. The following example demonstrates how information may be obtained through cascading or chained queries in order to obtain large quantities of meaningful data from only several known pieces of information.

Ron is shopping for clothing at an outlet mall while vacationing in San Diego (Step 200). When Ron settles on several items of clothing from Pacific Casualwear, the merchant scans barcodes that are printed on the price tags on the items that Ron is purchasing (Step 205). The item prices and sales tax is tabulated to provide Ron with the total sale amount. Ron slides his Visa credit card through a card reader of the merchant's POS terminal. Thereafter, the sale information including a merchant identifier, charge amount, credit card number and other transaction specific information is sent over a payment network where it is received at a wallet gateway (Step 210). The wallet gateway identifies the appropriate payment processor and formats the sales data into a properly formatted authorization request before sending the request to the processor for authorization (Step 215). The merchant identifier, a consumer identifier, and transaction related information are sent to a cataloging service by the wallet gateway (Step 220). The cataloging service receives the data and processes it to identify the data types and to locate web services that are best configured to retrieve additional information based on the data types (Step 225).

In one embodiment, the cataloging service maintains a listing of the available web services. It also maintains parameter requirements that correspond to each web service. Therefore, the cataloging service creates and sends one or more request messages, which include the required parameters that are obtained from the data received from the wallet gateway (Step 230). The request, including any required additional information, is transmitted over a network to the one or more identified web services for processing.

When a web service receives the request, it calls a function that reads a consumer identifier parameter and sends queries to various databases located at various computing systems to obtain information that directly or indirectly relates to the consumer (Step 235). Upon executing the database queries the web service is able to locate information that indicates that the consumer has shopped at an affiliated merchant located in Austin, Tex. Based on additional information corresponding to the consumer identifier, the web service retrieves the consumer's full name, mailing address, and telephone number. This information may be passed back to the cataloging service or passed to another web service for additional processing (Step 240). From the information retrieved by the first web service, a second web service is able to identify the consumer's employer and access travel records for trips that were booked through Ron's employer (Step 245).

Having information that indicates that Ron resides in Austin, Tex., another web service may be invoked to query a weather forecasting system to determine the present weather conditions as well as predicted temperatures and general conditions over the next several weeks. Because one web service was able to determine that Ron frequently travels to Chicago for his employer, weather conditions for Chicago may also be queried. Still, another web service may determine that Ron has made several purchases from an affiliated children's clothing store in Austin. A loyalty database associated with this clothing store may identify the names and ages of Ron's two children as well as the name of his wife. A query by another web service using Ron's wife's identity may reveal that she has recently purchased three pairs of shoes from a shoe store, which is also a subscriber to the acquisition system. A query of Austin news stories quotes Ron in a news story about an acquisition by his employer. A query about the acquisition shows that Ron's employer purchased a restaurant chain that is based in Chicago.

The above is a simple demonstration of how a small amount of information can be used to obtain a very large amount of details relating to a consumer or group of consumers. The process of calling various web services to query additional data sources using information obtained by previous web services may continue through many layers, thereby creating a cascading affect, wherein a single piece of information produces two additional pieces of information, which then results in six more pieces of information, and so on. From this, it becomes easy to see that a great deal of intelligence can be obtained in short order, even when starting with only minimal knowledge.

Upon acquiring defined types of information relating to Ron, this information may be stored in a demographic database. With such information available, an acquisition system subscriber may subsequently request information for consumers that meet very specific criteria in order to direct a marketing campaign to a very exclusive set of consumers that are most likely to respond positively to the campaign. This allows the marketer to focus limited resources in directions with the highest probabilities for return.

Prior to accessing the cataloging service to obtain defined information, the wallet server first determines whether such information is already available within, for example, a profile residing at the wallet gateway. As such, a subset of the information illustrated in the preceding example may be quickly obtained from the wallet data 115 thereby reducing the time and processing overhead required to collect the data from outside sources. Moreover, if at any point of the cumulative process of data gathering as previously illustrated, it is found that a parameter may be obtained from the wallet data 115, the mobile device data 105, or the transaction data 110; the parameter is retrieved from the source to be used as parameters to continue to cumulative data collection process.

Note that a great deal of information may be obtained about a consumer without directly revealing information from the ISO 8583 message, which may be considered to be private. However, an accurate likeness of the consumer is constructed for a user of the disclosed acquisition system, which may be used to profile a group of consumers to receive an offer to participate in, for example, an invitation only promotional event.

In order to direct offers to consumers who resemble the constructed likeness, methods may be implemented to allow consumer identities to be revealed for the purpose of directing direct mail, email, phone calls, and etc. to the individual consumers, without revealing additional private information. Similar systems and methods are disclosed in, for example, U.S. Patent Publication No. 2013/0117170 filed on Dec. 6, 2011, and entitled “System and Method for Secure Provision of Customer Data in a Loyalty Program”; U.S. Patent Publication No. 2013/0117128 filed on Dec. 6, 2011, and entitled “System and Method for Secure Marketing of Customer Data in a Loyalty Program”; and U.S. Patent Publication No. 2013/0117126 filed on Nov. 7, 2011, and entitled “System and Method for Secure Management of Customer Data in a Loyalty Program”, each of which are each incorporated by reference. Moreover, each of the Patent Publications were commonly owned at the time of the invention disclosed herein.

In an embodiment, the process described above may be similarly implemented, but at a date/time that is significantly later than the transaction date/time. As disclosed herein, one or more web services are executed based on information received from the wallet gateway at the time of a transaction. In accordance with this embodiment, the information acquisition process utilizing web services is invoked at a later date/time using historic transaction data. As such, POS transactions are invoked by the merchant, an authorization request is processed over a payment network, and the transaction data is stored by the wallet gateway or any other payment network component herein described. At a later date/time, an acquisition system subscriber may request information identifying customer personas that fall within defined parameters.

In one embodiment, web services may search for additional information corresponding to parameters from the transaction data, wherein the additional information also corresponds to the date of the transaction. In another embodiment, the web services may search for and retrieve related information in real-time. For example, if a transaction date falls several months prior to a search for related information, the relevant information pertaining to the consumer may have significantly changed. As such, a web service search for real-time information may be desired. In yet another embodiment, information relevant to a transaction may be comprise both historic and real-time data.

In one embodiment, the acquisition system subscriber may interact with a report interface from a personal computing device. The report interface provides options that allow the subscriber to define parameters for customer information. The subscriber may also be provided with controls to select what type of information the subscriber is interested in. For example, the subscriber may have a need for basic demographic data defining consumers who purchased a certain product from an identified merchant and between a defined beginning and end date/time. The acquisition system subscriber may also have a need for significantly detailed information that includes the basic demographic data along with weather conditions, taxing authorities, relevant news events at the time of sale, social events within a five-mile perimeter of the transaction, and competing merchants within as one-mile perimeter.

Having the report data defined, a request including report definitions is sent to the wallet gateway. The wallet gateway retrieves stored transaction data for customer falling within the defined parameters and formats the data, if necessary. The customer transaction data is sent along with the report definitions from the wallet gateway to the cataloging service where web services are identified, parameters are constructed and function calls are sent to the identified web services.

As described herein, the step of identifying and calling web services may be an iterative process, depending on the type of information that is requested. For example, it is often necessary to retrieve a first data set in order to extract information necessary to retrieve a second data set. Therefore, several iterations of calling web services may be required in order to obtain the information needed to provide the acquisition system subscriber with a requested level of detail.

When all of the information required to provide the subscriber with the requested data has been retrieved, it may be formatted by the wallet gateway prior to sending it to the subscriber. The information may be presented in report format either on screen or to be printed. The interface may also include additional research tools that allow the acquisition system subscriber to analyze the information further or reformat it in accordance with the subscriber's needs or preferences.

In one embodiment, the disclosed system may enable an online merchant to receive a credit card processor's best rate based on “card present” transactions. Normally, online merchants pay a higher transaction fee because the risk of fraud is higher than a traditional POS device would incur. Because a normal POS device requires the cardholder to be present when using a credit card for a purchase, it is considered a “card present” transaction and the risk of fraud is minimal. In an online merchant environment, a credit card purchase can be made with no practical means for verifying that the cardholder is who he says he is.

By way of the disclosed acquisition system, a user may facilitate a purchase using their smartphone as the payment instrument at a merchant location. Presently, smartphones equipped with wallet applications are able to transmit transaction account information directly to the merchant POS device or even bypass the merchant POS device entirely by sending the transaction account information directly to a payment gateway. By determining that the smartphone GPS coordinates match the merchant's GPS coordinates, the card processor can have assurance that the cardholder is truly present at the merchant location. Therefore, a “card present” transaction may occur even when a credit card is never presented for payment.

As used herein, the terms “cardholder,” “consumer,” “customer”, “user”, or “accountholder” may be used interchangeably with each other, and each shall mean any person, entity, machine, hardware, software, and/or business that enters into a financial agreement with a business or merchant. Furthermore, the terms “business” or “merchant” may be used interchangeably with each other and shall mean any person, entity, machine, hardware, software, or business that enters into a financial agreement with a cardholder. Further still, the merchant may be any person, entity, software, and/or hardware that is a provider, broker, and/or any other entity in the distribution chain of goods or services.

As used herein, a “POS device” or “remote device” may comprise any hardware, software, or combination thereof, configured to invoke and/or facilitate communication and/or transactions over a carrier network. More specifically, it should be noted that the remote device may be embodied as any combination of hardware and/or software components configured to interact with various other hardware and/or software components to facilitate interaction with the disclosed web services, remote applications, or functions to obtain information based on known parameters. For example, the remote device may include a cash register system or a smartphone equipped with a microprocessor, memory for executing machine readable instructions, and a credit card reader. Moreover, practitioners will appreciate that the terms “smartdevice”, “communication device”, “smart phone”, “smartphone”, “mobile phone”, and “cell phone” may be used interchangeably without departing from the scope of the invention.

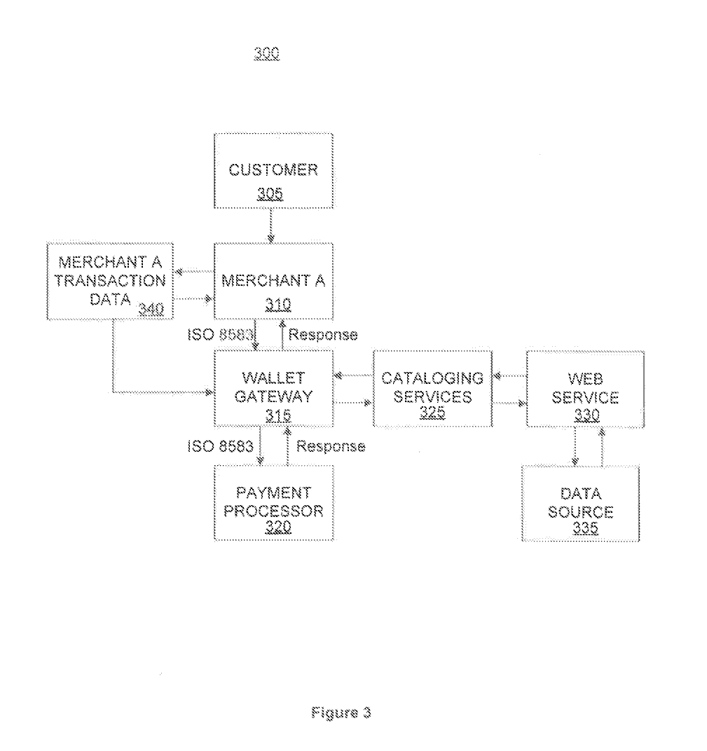

FIG. 3 is a combination system diagram and flow diagram illustrating acquisition system components and their interactions for batch augmentation of historic transactional data with relevant historical data in accordance with an exemplary embodiment of the present invention. In one embodiment, transactional data may be processed after-the-fact, wherein it is augmented with additional relevant information that is useful to a number of business practices. By after-the-fact, it is meant that basic transaction related data is saved to a database in the conventional manner for later potential use. The transactional data includes information that is directly related to a sale transaction including, for example, the date of the sale, merchant identifier, customer identifier, location of the sale, items purchased, purchase price, tax amounts, tax authorities, any discounts applied, etc. This is static data that may be later used for reporting purposes and audit. Because that data exists, it is possible for a broader picture of the transaction to be compiled at a later date and if desired, in batch form.

While augmenting transactional data in accordance with this embodiment may be suitable or even preferred under certain circumstances, it should be understood that some limitation may exist in that additional information relating to transactional data may not be available at a later date. However, this embodiment may be preferred when a large amount of data relating to many customers is desired for trend analysis and any other types of data analysis.

When a data consumer (i.e., Merchant B) 305 is a subscriber to the acquisition system, access to various data elements may be allowed and restricted in accordance with regulations, laws, merchant policies, subscription levels, and the like. However, when access is allowed, merchant B 305 may connect to the wallet gateway 310. This may be done in a conventional manner such as, for example, using a web interface to select a data provider and/or data set and enter security credentials to be validated by the wallet gateway 310. Merchant B 305 may further be provided with an interface to allow for the selection of specific criteria and filters to apply when compiling information. When the desired information has been defined, the request is sent from Merchant B 305 to the wallet gateway 310. Wallet gateway 310 receives the request and formats a request to be sent to a cataloging service 320. The cataloging service maintains lists of available web services, the types of data provided by each, as well as their parameter requirements.

Based on the request from the wallet gateway 310, the cataloging service 320 identifies the appropriate web services and retrieves the required parameters from the wallet server 310 request. A call that includes the required parameters is sent to each identified web service 325, which formats a query, establishes connections with one or more external systems (i.e. Independent DB system 330), and executes the query against the independent DB system 330. If data is returned from the query, the web service 325 formats the results and sends them to the cataloging service 320. When results have been received from each called web service 325, the data is sent to the wallet gateway 310, where it is combined with the transactional data that is retrieved from merchant A 315 and formatted in accordance with Merchant B's instructions. Transactional data from Merchant A 315 comprises any data that is saved as a result of the original transaction. In addition to merchant, product, service, and consumer information, the transaction data may include environmental variables that were determined by the customer's mobile device (if used) to facilitate the transaction. The compiled and formatted data is sent from the wallet gateway 310 to Merchant B 305.

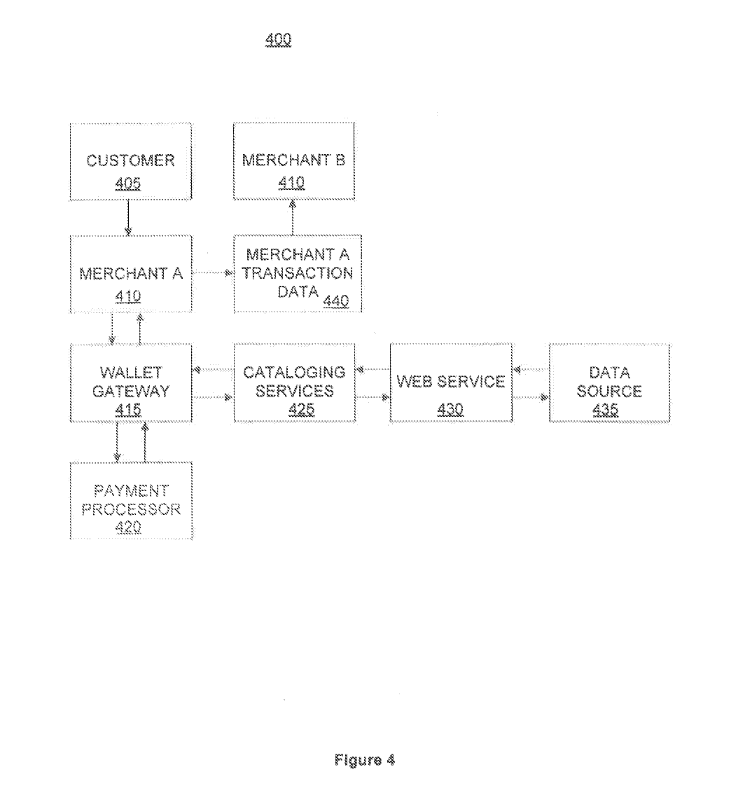

With reference to FIG. 4, the system 400 comprising a number of disparate computing systems and components provides an infrastructure for facilitating the features of the disclosed data provisioning system. The system 400 includes a customer 405 that facilitates purchase transaction with a merchant 410 either at a traditional retail store or an online store utilizing the Internet. Regardless of the purchase means, merchant 410 includes a POS device that is used to capture transaction details and communicate with a payment network in order to request and receive payment authorizations from a payment processor 420. The payment network may include a number of servers, nodes, and routers, which for simplicity are not illustrated nor will they be discussed except where directly relevant to the disclosed system.

In an embodiment of the invention, the disclosed system includes a gateway server or wallet gateway 415, which provides, via a network, a connection with the POS of merchant 410 and for facilitating origination, transmission, and receipt of wallet data that is maintained at the wallet gateway 415. In one embodiment, the wallet gateway 415 serves as the primary intercept point for transactions originating at a merchant 410 POS device or any other entity that compiles and sends a payment authorization request to a payment processor 420. Accordingly, the wallet gateway 415 receives transaction information in the form of an authorization request, extracts data needed to facilitate the disclosed data acquisition features, and routes the authorization request to an appropriate payment processor 420 for transaction authorization. When the payment processor 420 has processed the transaction request, an authorization response is sent back to the wallet gateway 415 where any number of functions can be performed on the message in accordance with any data acquisition features as disclosed herein. Finally, the authorization response is sent from the wallet gateway 415 to the merchant 410 POS device.

While various embodiments for processing transaction requests are presented herein in accordance with the disclosed information acquisition features, practitioners will appreciate that the ordering of routing and processing steps are presented for explanation only and are not intended to limit the scope of the invention. The variously disclosed processing and transmission steps may be performed by any number of computing devices or may be performed by a combination of devices and in varying orders. For example, the wallet gateway 415 may modify a transaction authorization request based on loyalty information prior to passing the request to the payment processor 420. In another example, the wallet gateway 415 may not modify the authorization request, but instead modify the authorization response received from the payment processor 420 based on, for example, data retrieved by a web service 430 by way of a cataloging service 425.

In one embodiment, merchant A 410 and merchant B 445 subscribe to one or more services offered by the wallet gateway 415, which serves as a data broker through interaction with any number of cataloging services 425 and web services 430. As will be disclosed in greater detail herein, web services 430 are configured to retrieve data from external or data source 435. Accordingly, the wallet gateway 415 may directly maintain or have access to merchant specific information through, for example, an ISO 8583 message. Such information may include, for example, merchant names, addresses, merchant types, product or service offerings, customer demographics, etc. As such, when a payment authorization request (e.g. ISO 8583) passes through the wallet gateway 415 in route to a payment processor 420, information relating to merchant A 410 may be retrieved in order to augment data relating to the transaction. This provides a more holistic view of the purchase transaction, which may be subsequently used as a single dataset that influences the overall analysis, compilation, and provisioning of real-life transaction data from a data broker (e.g., wallet gateway) to an acquisition system subscriber. Subscribers (e.g., merchant A 410 and Merchant B 445) may subsequently use such information to develop long-term marketing strategies, loyalty programs, special promotions, and the like.

Laws, regulations, and public opinion have been successful in disassociating personal identities from commercial marketing efforts. However, the need to maintain personal privacy has limited marketing activities in that strategies are modeled in light of derived customer personas (i.e., demographics), rather than on the customer 405 directly. This results in a compilation of highly generalized data that lacks the precision that marketers would prefer to utilize. However, the wallet gateway 415 and associated components described herein are uniquely positioned and configured to provide customer specific information while adequately maintaining the anonymity of the customer 405.

In one embodiment, the described system may be combined with a customer 405 loyally or rewards program. Such programs are presently implemented at nearly every level of the retail sales industry. However, rewarding consumers 405 based on their purchasing activity has not been limited to the retail market alone. Corporate customers 405 are often provided various incentives by wholesale venders, for example.

When a customer loyalty account is established, it can represent a trust-based relationship that the consumer 405 has with the merchant 410. In other words, the consumer 405 participates in such a program knowing that there will be an ongoing purchasing relationship with the merchant 410 in the future. A consumer's decision to participate in a loyalty program can also be indicative of a level of trust that the consumer 405 has for the merchant 410. For example, because enrollment in such a program most often requires the consumer 405 to provide personal information to the merchant (e.g., name, address, phone number, family size, names of family members, etc.). Moreover, in order to keep track of future purchases for the purpose of reward issuance, it can be assumed that the merchant 410 will also have knowledge regarding what products the consumer 405 regularly purchases.

For the reasons discussed above, a loyalty program provides a unique scenario where the privacy barrier between the consumer 405 and merchant 410 is lowered to some degree. Therefore, marketing efforts can ultimately be customized for the customer 405 directly based on known static information (e.g., family size, occupation, residence type) as well as cumulative data (e.g., items purchase on previous visit, repeat purchases, frequency of purchases, sale total, payment method). Having this detail of customer information makes loyalty programs attractive to merchants. Targeting offers based on specific customer information has been demonstrated to be significantly more effective than marketing in accordance with demographic data alone. However, this information is only useful to the administering merchant. Providing or selling such personal information to third-parties, such as merchant B 445 would likely harm the trust relationship between the customer 405 and the merchant 410. In some cases, the merchant 410 may lose otherwise loyal customers entirely.

In some circumstances, it might be advantageous for the merchant 410 to share at least a subset of their customer's information with other merchants. Other merchants may include affiliated merchants, merchants that share a physical location (e.g., stores in a mall), merchants owned by a shared entity, merchants that have entered into a referral agreement, etc. Moreover, merchants 410 may receive financial compensation for information regarding participants in their loyalty program. In order to receive these and other benefits from sharing such information, a merchant 410 should be certain that users of the data receive full benefit of targeting individual customers, while not exposing the customer's identity. This feature can be provided by the disclosed wallet gateway, catalog services, and web services.

In one embodiment, a merchant 410 identifies a customer 405 as a loyalty program participant through any number of methods including, for example, presentation of a loyalty card that can be scanned by a card reader, matching a credit card number with a number that is associated with a loyalty account, entering the customer's telephone number at the POS, and the like. When the customer 405 is identified as a loyalty participant, the participant may choose to pay with cash, credit card, charge card, or gift card. When a credit card or charge card is used to facilitate payment, an authorization message is sent over a payment network where it is received by the wallet gateway 415, the wallet gateway 415 identifies the appropriate payment processor 420, formats the request in accordance with the requirements of the payment processor 420, and sends the authorization request to the payment processor 420 for authorization. In addition to a credit or charge card number, the information received from the merchant 410 POS includes a merchant identifier, customer identifier, and product or service identifier(s).

The wallet gateway 415 may be configured to process loyalty transactions or may forward information for loyalty transactions to a loyalty server (not shown). The loyalty server maintains rules for the merchant's loyalty program, stores “points” or other information that is used in calculating a gift or discount value and whether the purchase entitles the customer to receive a gift or discount. The loyalty server also stores the transaction data, such that cumulative purchase data can be used to track customer performance and to later qualify a customer 405 for a gift, discount, or the like. Those of ordinary skill will appreciate that the features of the loyalty server may be performed by a uniquely configures server residing on a payment network, or may reside as an application and database residing on any other component on the payment network, including the wallet gateway 415.

In one embodiment, the loyalty server stores transactional data such that the identity of the customer 405 resides in a separate data table and is linked to transactional data by a key value. Any other information considered to be private can be stored in a similar manner. For example, a customer address table may exist that stores the physical address for the customer 405 and/or email address, telephone numbers, etc. Again, the records among the various table may be linked by a key value.

In one embodiment, the loyalty server is further configured to receive requests for customer information, retrieve the relevant customer information, and send the information over a network to the requester. The loyalty server may be configured to parse customer data to remove certain data fields that could be used to identify the customer 405. In another embodiment, the loyalty server simply retrieves all of the information from a transaction database, wherein the transaction and/or customer information matches the requestor's criteria. Because sensitive data is already stored separately from the transactional data, there is no need to parse the data prior to sending it to the requesting entity.

In one embodiment, the merchant 410 owner of the customer data may determine what types of data are sensitive, and therefore should not be included in requested data. In still another embodiment, the loyalty participant may be allowed to identify information that may be shared while also defining data types that are not to be shared.

The data collected over the course of a loyalty program, for example, represents real-word information that directly corresponds to an unidentified customer 405. This offers a clear advantage over data that is compiled based on a process of deriving averages and trends to create demographic data. A consumer of merchant loyalty program data enjoys the ability to direct offers and promotions to customers based on one or more pieces of information that associates a customer 405 to a series of transactions, while not identifying the identity of the customer 405. For example, a loyalty participant identifier might stand in the place of the customer's name. As such, the consumer of the loyalty data is able to identify the owner of a series of transactions without having information that could be user to reveal the name of the customer or any other information that is determined to be sensitive.

In one embodiment, further to not revealing the identity of a customer 405 in data sold or provided to another merchant (e.g., merchant B 445), all contact information is also withheld from the consumer of the customer data. This further ensures that the identity of the customer 405 cannot be determined by simply looking up the mailing address on a web site that provides access to public data such as home ownership. In accordance with this embodiment, the data consumer merchant 445 is provided with a list of customers identified only by general information along with transactional data that is associated with each listed customer. The customer record is assigned a unique identifier that is known only to the owner of the data (e.g., the merchant 410 providing the loyalty program). When the consumer 445 of the customer data identifies a subset of customers that she would like to email promotional information to, the promotional email content is provided along with a list of customer identifiers to the owner of the customer data. A system receives this information, retrieves name and email address information for each customer corresponding to the unique identifier, and sends the promotional email to each customer included in the list.

In one embodiment, a trusted third-party server is configured to manage distribution of marketing material to anonymous customers on behalf of the consumer 445 of the customer information. The trusted third-party server may be the wallet gateway 415 or any other computing system disclosed herein. The server is highly secured and may be configured with limited access to data residing at the merchant owner 410 of the customer data. The trusted third-party may further have access to the wallet gateway 415 and/or direct access to services catalogs and web services such that information requested by the consumer of customer data can be augmented with additional information, as disclosed herein. For example, a customer record may include descriptors of items purchased on a certain date as well as the location of the purchase. The third-party or wallet gateway 415 may send a request to a cataloging service 425 requesting environmental (e.g., temperature, humidity, precipitation, etc.) information relevant to the purchase data. The services catalog identifies a weather web service that is capable of accessing the National Weather Service archives. The weather web service is configured to receive a date and a postal code as parameters to retrieve historic weather data. The data is returned to the third-party server where it is integrated and formatted to be sent to the data consumer. When the data consumer 445 receives the data, it includes not only information relating to one or more customer transactions, but also includes temperature, wind, and precipitation information that can be used by the data consumer to further analyze the data to make precise marketing decisions.

Those of ordinary skill in the art will appreciate that merchant data may comprise many combinations of transactional data including information relating to, for example, merchant 410, customer 405, payment account, and product or service. The disclosed system may utilize various data storage configurations including local data storage, server storage, cloud-based storage, and the like. Moreover, it should be appreciated that the disclosed functionality may be performed by a proprietary merchant based system or a network accessible service that is incorporated within an existing payment network infrastructure.

Communication between various entities of the invention is accomplished through any suitable communication means, such as, for example, a telephone network, intranet, Internet, payment network, online communications, off-line communications, wireless communications, and/or the like. One skilled in the art will also appreciate that, for security reasons, any databases, systems, or components of the present invention may consist of any combination of databases or components at a single location or at multiple locations, wherein each database or system includes any of various suitable security features, such as firewalls, access codes, encryption, decryption, compression, decompression, and/or the like.

A transaction card may communicate to the merchant, information from one or more data sets associated with the transaction card. In one example, membership data and credit/debit card data associated with a transaction account or device may be transmitted using any conventional protocol for transmission and/or retrieval of information from an account or associated transaction card (e.g., credit, debit, gift, stored value, loyalty, etc.). In another embodiment, a transaction card may comprise an electronic coupon, voucher, or other such instrument. In yet another embodiment, the transaction card may be configured to communicate via Radio Frequency (RF) signals. As such, the data maintained by the transaction card may be communicated via RF signals.

The transaction card in accordance with this invention may be used to pay for acquisitions, obtain access, provide identification, pay an amount, receive payment, redeem reward points, and/or the like. In the RF embodiments, instrument to instrument transactions may also be performed. See, for example, Sony's “Near Field Communication” (“NFC”) emerging standard which is touted as operating on 13.56 MHz and allowing the transfer of any kind of data between NFC enabled devices and across a distance of up to twenty centimeters. See also, Bluetooth chaotic network configurations; described in more detail at http://www.palowireless.com/infotooth/whatis.asp, which is hereby incorporated by reference. Furthermore, data on a first RF device may be transmitted directly or indirectly to a second RF device to create a copy of all or part of the original device.

The transaction card may be associated with various applications which facilitate participation in various programs such as, for example, loyalty programs. A loyalty program may include one or more loyalty accounts. Exemplary loyalty programs include frequent flyer miles, on-line points earned from viewing or purchasing products or websites on-line and programs associated with diner's cards, credit cards, debit cards, hotel cards, calling cards, and/or the like.

As disclosed herein, a transaction card is normally associated with a transaction account. Generally, the user is both the owner of the transaction account and the participant in the loyalty program; however, this association is not required. For example, a participant in a loyalty program may gift loyalty points to a user who pays for a purchase with his own transaction account, but uses the gifted loyalty points instead of paying the monetary value.

The transaction card maintains a transaction account identifier linking the transaction card to a transaction account. A “transaction account identifier”, “code,” “account,” “account number,” “account code”, “identifier,” “loyalty number” or “membership identifier,” as used herein, includes any device, code, or other identifier/indicia suitably configured to allow the consumer to interact or communicate with the system such as, for example, authorization/access code, Personal Identification Number (PIN), Internet code, other identification code, and/or the like that is optionally maintained on and/or by a NACV module, SIM card, rewards card, charge card, credit card, debit card, prepaid card, telephone card, smart card, magnetic strip card, bar code card, radio frequency card and/or the like.

The transaction account identifier may be distributed and stored in any form of plastic, electronic, magnetic, radio frequency, audio and/or optical device capable of transmitting or downloading data from itself to a second device. A transaction account identifier may be, for example, a sixteen-digit credit card number, although each credit provider has its own numbering system, such as the fifteen-digit numbering system used by an exemplary loyalty system. Each provider's credit/debit card numbers comply with that provider's standardized format such that the provider using a sixteen-digit format may generally use four spaced sets of numbers, as represented by the number “0000 0000 0000 0000”. The first five to seven digits are reserved for processing purposes and identify the issuing bank, card type and etc. In this example, the last sixteenth digit is used as a sum check for the sixteen-digit number. The intermediary eight-to-ten digits are used to uniquely identify the customer. In addition, loyalty account numbers of various types may be used.

The “transaction information” in accordance with this invention may include the nature or amount of transaction, as well as, a merchant, user, and/or issuer identifier, security codes, routing numbers, and the like. In various exemplary embodiments, one or more transaction accounts may be used to satisfy or complete a transaction. For example, the transaction may be only partially completed using the transaction account(s) correlating to the application tenant information stored on the transaction card with the balance of the transaction being completed using other sources. Cash may be used to complete part of a transaction and the transaction account associated with a user and the transaction card, may be used to satisfy the balance of the transaction. Alternatively, the user may identify which transaction account, or combination of transaction accounts, the user desires to complete a transaction. Any known or new methods and/or systems configured to manipulate the transaction account in accordance with the invention may be used.

In various exemplary embodiments, the transaction card may be embodied in form factors other than, for example, a card-like structure. As previously noted, the transaction card may comprise a RF transponder, a speed pass, store discount card, or other similar device. The transaction card may furthermore be associated with coupons. A typical RF device which may be used by the present invention is disclosed in U.S. application Ser. No. 12/553,901, entitled “System and Method for Facilitating Secure Voice Communication Over a Network”, which is commonly assigned, and which is hereby incorporated by reference.

One skilled in the art will appreciate that a network may include any system for exchanging data or transacting business, such as the Internet, an intranet, an extranet, WAN, LAN, satellite communications, cellular network, and/or the like. It is noted that the network may be implemented as other types of networks such as, for example, an interactive television (ITV) network. The users may interact with the system via any input device such as a keyboard, mouse, kiosk, personal digital assistant (e.g., Palm Pilot®.), handheld computer, cellular phone, and/or the like. Similarly, the invention may be used in conjunction with any type of personal computer, network computer, workstation, minicomputer, mainframe, or the like running any operating system such as any version of Windows, Windows XP, Windows Vista, Windows NT, Windows 2000, Windows 98, Windows 95, Android, Google Chrome, MacOS, OS/2, BeOS, Linux, UNIX, Solaris, or the like. Moreover, although the invention is frequently described herein as being implemented with specific communications protocols, it may be readily understood that the invention could also be implemented using HTTP, TCP/IP, SMTP, Bluetooth, IPX, AppleTalk, IP-6, NetBIOS, OSI or any number of existing or future protocols. Moreover, the system may contemplate the use, sale or distribution of any goods, services or information over any network having similar functionality described herein.

Any databases discussed herein may be any type of database, such as relational, hierarchical, graphical, object-oriented, and/or other database configurations. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, and/or the like. The association step may be accomplished by a database merge function, for example, using a “key field” in pre-selected databases or data sectors.

More particularly, a “key field” partitions the database according to the high-level class of objects defined by the key field. For example, certain types of data may be designated as a key field in a plurality of related data tables and the data tables may then be linked on the basis of the type of data in the key field. In this regard, the data corresponding to the key field in each of the linked data tables is preferably the same or of the same type. However, data tables having similar, though not identical, data in the key fields may also be linked by using AGREP, for example. In accordance with one aspect of the present invention, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); block of binary (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one exemplary embodiment, the ability to store a wide variety of information in different formats is facilitated by storing the information as a Binary Large Object (BLOB). Thus, any binary information may be stored in a storage space associated with a data set. As discussed above, the binary information may be stored on the financial transaction card or external to but affiliated with the financial transaction card. The BLOB method may store data sets as ungrouped data elements formatted as a block of binary via a fixed memory offset using fixed storage allocation, circular queue techniques, or best practices with respect to memory management (e.g., paged memory, least recently used, etc.). By using BLOB methods, the ability to store various data sets that have different formats facilitates the storage of data associated with the financial transaction card by multiple and unrelated owners of the data sets. For example, a first data set which may be stored may be provided by a first issuer, a second data set which may be stored may be provided by an unrelated second issuer, and yet a third data set which may be stored, may be provided by an third issuer unrelated to the first and second issuer. Each of these three exemplary data sets may contain different information that is stored using different data storage formats and/or techniques. Further, each data set may contain subsets of data, which also may be distinct from other subsets.

The data set annotation may be used for various types of status information as well as other purposes. For example, the data set annotation may include security information establishing access levels. The access levels may, for example, be suitably configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified merchants are permitted to access the data set for reading, and others are altogether excluded from accessing the data set. However, other access restriction parameters may also be used allowing various entities to access a data set with various permission levels as appropriate.

One skilled in the art will also appreciate that, for security reasons, any databases, systems, devices, servers or other components of the present invention may consist of any combination thereof at a single location or at multiple locations, wherein each database or system includes any of various suitable security features, such as firewalls, access codes, encryption, decryption, compression, decompression, and/or the like.

The present invention may be described herein in terms of functional block components, optional selections and/or various processing steps. It should be appreciated that such functional blocks may be realized by any number of hardware and/or software components suitably configured to perform the specified functions. For example, the present invention may employ various integrated circuit components, e.g. memory elements, processing elements, logic elements, look-up tables, and/or the like, which may carry out a variety of functions under the control of one or more microprocessors or other control devices. Similarly, the software elements of the present invention may be implemented with any programming or scripting language such as C, C++, Java, COBOL, assembler, PERL, Visual Basic, SQL Stored Procedures, extensible markup language (XML), Microsoft.Net with the various algorithms being implemented with any combination of data structures, objects, processes, routines or other programming elements. Further, it should be noted that the present invention may employ any number of conventional techniques for data transmission, messaging, data processing, network control, and/or the like. Still further, the invention could be used to detect or prevent security issues with a client-side scripting language, such as JavaScript, VBScript or the like. For a basic introduction of cryptography and network security, the following may be helpful references: (1) “Applied Cryptography: Protocols, Algorithms, And Source Code In C,” by Bruce Schneier, published by John Wiley & Sons (second edition, 1996); (2) “Java Cryptography” by Jonathan Knudson, published by O'Reilly & Associates (1998); (3) “Cryptography & Network Security: Principles & Practice” by Mayiam Stalling, published by Prentice Hall; all of which are hereby incorporated by reference.

It should be appreciated that the particular implementations shown and described herein are illustrative of the invention and its best mode and are not intended to otherwise limit the scope of the present invention in any way. Indeed, for the sake of brevity, conventional data networking, application development and other functional aspects of the systems (and components of the individual operating components of the systems) may not be described in detail herein. It should be noted that many alternative or additional functional relationships or physical connections might be present in a practical transaction card distribution system.

As may be appreciated by one of ordinary skill in the art, the present invention may be embodied as a method, a data processing system, a device for data processing, a financial transaction card, and/or a computer program product. Accordingly, the present invention may take the form of an entirely software embodiment, an entirely hardware embodiment, or an embodiment combining aspects of both software and hardware or other physical devices. Furthermore, the present invention may take the form of a computer program product on a tangible computer-readable storage medium having computer-readable program code means embodied in the storage medium. Any suitable tangible computer-readable storage medium may be utilized, including hard disks, CD-ROM, optical storage devices, magnetic storage devices, and/or the like.

These computer program instructions may also be stored in a computer-readable memory that may direct a computer or other programmable data processing apparatus to function in a particular manner, such that the instructions stored in the computer-readable memory produce an article of manufacture including instruction means which implement functions of flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus include steps for implementing the functions specified in the flowchart block or blocks.

In the foregoing specification, the invention has been described with reference to specific embodiments. However, it may be appreciated that various modifications and changes may be made without departing from the scope of the present invention. The specification and figures are to be regarded in an illustrative manner, rather than a restrictive one, and all such modifications are intended to be included within the scope of present invention. Accordingly, the scope of the invention should be determined by the appended claims and their legal equivalents, rather than by the examples given above. For example, the steps recited in any of the method or process claims may be executed in any order and are not limited to the order presented.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical.”

What is claimed is:

1. A method for augmenting consumer related information, the method comprising the steps of:
receiving, at a gateway server, a payment authorization request from a merchant system for a payment transaction;
parsing, at the gateway server, the payment authorization request to obtain transaction data utilized in the payment transaction;
obtaining, by the gateway server, wallet data from an electronic wallet application resident on a mobile device utilized in performing the payment transaction;
sending, by the gateway server, the transaction data and the wallet data to one or more web services that retrieve, from one or more data sources, supporting data based on its relation to a first parameter selected from the transaction data and a second parameter selected from the wallet data;
obtaining, by the gateway server, the supporting data from the one or more web services;
processing, by the gateway server, the supporting data to combine the transaction data and the wallet data with the supporting data; and
storing the combined data in a database system.

2. The method of claim 1 wherein the step of sending the transaction data and the wallet data comprises sending the transaction data to a plurality of different web services.

3. The method of claim 1 wherein the step of sending the transaction data and the wallet data comprises sending the wallet data to a plurality of different web services.

4. The method of claim 1 wherein the step of sending the transaction data and the wallet data comprises sending the transaction data to a first web service and sending the wallet data to a second web service.

5. The method of claim 1 wherein the combined data includes only information that cannot be used to identify an individual consumer.

6. A computer system for augmenting consumer related information, the system comprising:
a gateway server comprising
means for receiving a payment authorization request from a merchant system for a payment transaction,
a parser for parsing the payment authorization request to obtain transaction data utilized in the payment transaction;
means for obtaining wallet data from an electronic wallet application resident on a mobile device utilized in performing the payment transaction;
means for sending the transaction data and wallet data to one or more web services for retrieval of supporting data based on its relation to a first parameter selected from the transaction data and a second parameter selected from the wallet data,
means for obtaining the supporting data from the one or more web services, and
means for processing the supporting data to combine the transaction data and the wallet data with the supporting data; and
a database system for storing the combined data.

7. The system of claim 6 wherein the means for sending the transaction data and wallet data comprises means for sending the transaction data to a plurality of web services.

8. The system of claim 6 wherein the means for sending the transaction data and the wallet data comprises means for sending the wallet data to a plurality of web services.

9. The system of claim 6 wherein the means for sending the transaction data and the wallet data comprises means for sending the transaction data to a first web service and means for sending the wallet data to a second web service.

10. The system of claim 6 wherein the combined data includes only information that cannot be used to identify an individual consumer.

11. A method for retrieving historical consumer related information, the method comprising the steps of:
receiving, at a gateway server, a request for consumer information;
parsing, at the gateway server, the request to obtain criteria for selecting stored data;
retrieving, by the gateway server, transaction data corresponding to the criteria, the transaction data having been utilized in a payment transaction processed by a merchant system;
retrieving, by the gateway server, wallet data corresponding to the criteria, the wallet data from an electronic wallet application resident on a mobile device utilized in performing the payment transaction;
sending, by the gateway server, the transaction data and the wallet data to one or more web services for retrieval of supporting data based on its relation to a first parameter selected from the transaction data and a second parameter selected from the wallet data;
obtaining, by the gateway server, the supporting data from the one or more web services;
processing, by the gateway server, the supporting data to combine the transaction data and the wallet data with the supporting data; and
storing the combined data in a database system.

12. The method of claim 1 wherein the step of sending the transaction data and the wallet data comprises sending the transaction data to a plurality of different web services.

13. The method of claim 11 wherein the step of sending the transaction data and the wallet data comprises sending the wallet data to a plurality of different web services.

14. The method of claim 11 wherein the step of sending the transaction data and the wallet data comprises sending the transaction data to a first web service and sending the wallet data to a second web service.

15. The method of claim 11 wherein the combined data includes only information that cannot be used to identify an individual consumer.

16. A computer system for retrieving historical consumer related information, the system comprising:
a gateway server comprising
means for receiving a request for consumer information,
means for parsing the request to obtain criteria for selecting stored data,
means for retrieving transaction data corresponding to the criteria, the transaction data having been utilized in a payment transaction processed by a merchant system,
means for retrieving wallet data corresponding to the criteria, the wallet data from an electronic wallet application resident on a mobile device utilized in performing the payment transaction,
means for sending the transaction data and the wallet data to one or more web services for retrieval of supporting data based on its relation to a first parameter selected from the transaction data and a second parameter selected from the wallet data,
means for obtaining the supporting data from the gateway server, and
means for processing the supporting data to combine the transaction data and the wallet data with the supporting data; and
a database system for storing the combined data.

17. The system of claim 16 wherein the means for sending the transaction data and wallet data comprises means for sending the transaction data to a plurality of web services.

18. The system of claim 16 wherein the means for sending the transaction data and the wallet data comprises means for sending the wallet data to a plurality of web services.

19. The system of claim 16 wherein the means for sending the transaction data and the wallet data comprises means for sending the transaction data to a first web service and means for sending the wallet data to a second web service.

20. The system of claim 16 wherein the combined data includes only information that cannot be used to identify an individual consumer.
